(19) United States
(12) Patent Application Publication
(10) Pub. No.: US 2023/0334074 A1
(43) Pub. Date: Oct. 19, 2023

(54) METHOD AND SYSTEM FOR SEARCHING LANGUAGE-AGNOSTIC CODE-MIXED QUERIES

(71) Applicant: Flipkart Internet Private Limited, Bengalore (IN)

(72) Inventors: Mandar Shrikant Kulkarni, Pune (IN); Nikesh Garera, Bangalore (IN)

(21) Appl. No.: 18/146,585

(22) Filed: Dec. 27, 2022

(30) Foreign Application Priority Data
Apr. 19, 2022 (IN) 202241023104

(51) Int. Cl. G06F 16/33

(52) U.S. Cl. CPC G06F 16/3337

(57) ABSTRACT

A method and system for searching language-agnostic code-mixed queries are disclosed. The method includes receiving one or more code mixed vernacular queries, from one or more electronic devices. Further, the method includes obtaining one or more vector representations, which are similar to the one or more code mixed vernacular queries, from a database. Furthermore, the method includes retrieving one or more English queries corresponding to the obtained one or more vector representations. Thereafter, the method includes outputting one or more retrieved English queries corresponding to the one or more code mixed vernacular queries.

### CROSS-REFERENCE TO RELATED APPLICATIONS

This application claims the benefit under 35 U.S.C. § 119(b) of Indian Patent Application No. 202241023104, filed on Apr. 19, 2022, which application is incorporated herein by reference in its entirety.

### FIELD

The embodiments of the present disclosure generally relate to query handling systems. More particularly, the present disclosure relates to a method and a system for searching language-agnostic code-mixed queries.

### BACKGROUND

The following description of the related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of the prior art.

Generally, multilingualism may refer to a high degree of proficiency in two or more languages in the written and oral communication modes. It often results in language mixing, i.e., code-mixing, when a multilingual speaker switches between multiple languages in a single utterance of a text or speech. Online retail stores/online web content may have now become an integral part of user's lifestyle. With an ever-increasing catalog size, product search, web content search may be the primary means by which the user finds the specific content/item the user is interested in. A good search engine/application should be able to parse any query provided by the user, and display results that are most relevant. Some of the search engines/applications may allow users to browse and execute (i.e., shop, buy, download, etc.) in both English and Spanish (Español). Each version may display contents/products in a specific language (based on country or user preference) and allows search in that language. To ensure high user satisfaction, the search engine/application should be able to surface relevant results for queries typed in multiple languages, across multiple countries. As a representative example, there may be English-Hindi code-mixing, however, there are no similar inferences for other language pairs.

Conventionally, systems for the workflow of enabling code-mixed query search may include identifying the code-mix queries through a language detection module. The identified queries are then translated using any model built using query data. The English translation is then passed to the search Application Programming Interface (API) which may then retrieve relevant content/products to display to the user. To build a translation model, a large training corpus of data may be created using publicly available paid APIs, manual tagging, and the like. This process may be an expensive and time-consuming task. Further, for the user with vernacular languages (regional/native language), the major portion of the queries may be code-mixed queries i.e., the queries where vernacular language words are written in English (Roman) script. Currently, most of the search engines/applications may only support search with English, Spanish, Chinese, Hinglish (Hindi+English) code-mixed queries. Conventional systems may not support search with other code-mixed languages, which may lead to irrelevant search results.

Therefore, there is a need for a method and a system for solving the shortcomings of the current technologies, by providing a method and a system for searching language-agnostic code-mixed queries.

### SUMMARY

This section is provided to introduce certain objects and aspects of the present invention in a simplified form that are further described below in the detailed description. This summary is not intended to identify the key features or the scope of the claimed subject matter. In order to overcome at least a few problems associated with the known solutions as provided in the previous section, an object of the present invention is to provide a technique that may be for searching language-agnostic code-mixed queries.

It is an object of the present disclosure to provide a method and a system for searching language-agnostic code-mixed queries.

It is an object of the present disclosure to provide a similarity search-based approach for enabling search with code-mixed queries.

It is an object of the present disclosure to enable English and code-mix queries to be projected onto a common vector space, and the most similar English query is found through vector similarity search.

It is an object of the present disclosure to reduce the latency of the similarity search, using efficient hashing or index-based search methods.

It is an object of the present disclosure to use either encode only models, the decoder only models, or encoder-decoder models to obtain the vector representation of the query.

It is an object of the present disclosure to perform quantization of the vectors to speed up the search.

It is an object of the present disclosure to avoid translation of code-mix query to English query, which also adds labeling cost for the translation.

It is an object of the present disclosure to avoid manually labeling parallel corpus data of code-mixed queries, which may be time-consuming and expensive.

In an aspect, the present disclosure provides a method for searching language-agnostic code-mixed queries. The method includes receiving one or more code mixed vernacular queries, from one or more electronic devices. Further, the method includes obtaining one or more vector representations, using one or more Machine Learning (ML) models for the one or more code mixed vernacular queries. Furthermore, the method includes retrieving one or more English queries corresponding to the obtained one or more vector representations, from the database of pre-determined vector representations of English queries, using a vector similarity or a requirement-based indexing technique or a hashing technique. Thereafter, the method includes outputting one or more retrieved English queries corresponding to the one or more code mixed vernacular queries.

In an embodiment, the one or more vector representations include embedded code-mix queries and English search queries into the common vector representation space.

In an embodiment, the one or more code mixed vernacular queries include one or more vernacular languages comprising regional languages, and wherein the one or more vernacular languages include one or more regional languages words that are written in English script.

In an embodiment, obtaining one or more vector representations is based on one or more English or multilingual models. The English or multilingual models includes at least one of, an encode only models, a decode only models, and encoder-decoder models.

In an embodiment, one or more vector representations is quantized to further speed up the search.

In another aspect, the present disclosure provides a system for searching language-agnostic code-mixed queries. The system receives one or more code mixed vernacular queries, from one or more electronic devices. Further, the system obtains one or more vector representations, using one or more Machine Learning (ML) models for the one or more code mixed vernacular queries. Furthermore, the system retrieves one or more English queries corresponding to the obtained one or more vector representations, from the database of pre-determined vector representations of English queries, using a vector similarity or a requirement-based indexing technique or a hashing technique. Thereafter, the system outputs one or more retrieved English queries corresponding to one or more code mixed vernacular queries.

### BRIEF DESCRIPTION OF THE ACCOMPANYING DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry/sub components of each component. It will be appreciated by those skilled in the art that the invention of such drawings includes the invention of electrical components, electronic components, or circuitry commonly used to implement such components.

FIG. 1 illustrates an exemplary block diagram representation of a network architecture implementing a proposed system for searching language-agnostic code-mixed queries, according to embodiments of the present disclosure.

FIG. 2 illustrates an exemplary detailed block diagram representation of the proposed system, according to embodiments of the present disclosure.

FIG. 3 illustrates a flow chart depicting a method of searching language-agnostic code-mixed queries, according to embodiments of the present disclosure.

FIG. 4 illustrates a hardware platform for the implementation of the disclosed system according to embodiments of the present disclosure.

The foregoing shall be more apparent from the following more detailed description of the invention.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, “connect”, “configure”, “couple” and its cognate terms, such as “connects”, “connected”, “configured” and “coupled” may include a physical connection (such as a wired/wireless connection), a logical connection (such as through logical gates of semiconducting device), other suitable connections, or a combination of such connections, as may be obvious to a skilled person.

As used herein, “send”, “transfer”, “transmit”, and their cognate terms like “sending”, “sent”, “transferring”, “transmitting”, “transferred”, “transmitted”, etc. include sending or transporting data or information from one unit or component to another unit or component, wherein the content may or may not be modified before or after sending, transferring, transmitting.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Embodiments of the present disclosure provide a method and a system for searching language-agnostic code-mixed queries. The present disclosure provides a similarity search-based approach for enabling search with code-mixed queries. The present disclosure enables English and code-mix queries to be projected onto a common vector space, and most similar English query is found through vector similarity search. The present disclosure reduces the latency of the similarity search, using efficient hashing or index-based search methods. The present disclosure use either encode-only models, the decoder-only models, or encoder-decoder models to obtain the vector representation of the query. The present disclosure performs quantization of the vectors to speed up the search. The present disclosure avoids translation of code-mix query to English query, which also adds labeling cost for the translation. The present disclosure avoids manually labeling parallel corpus data of code-mixed queries, which may be time-consuming and expensive.

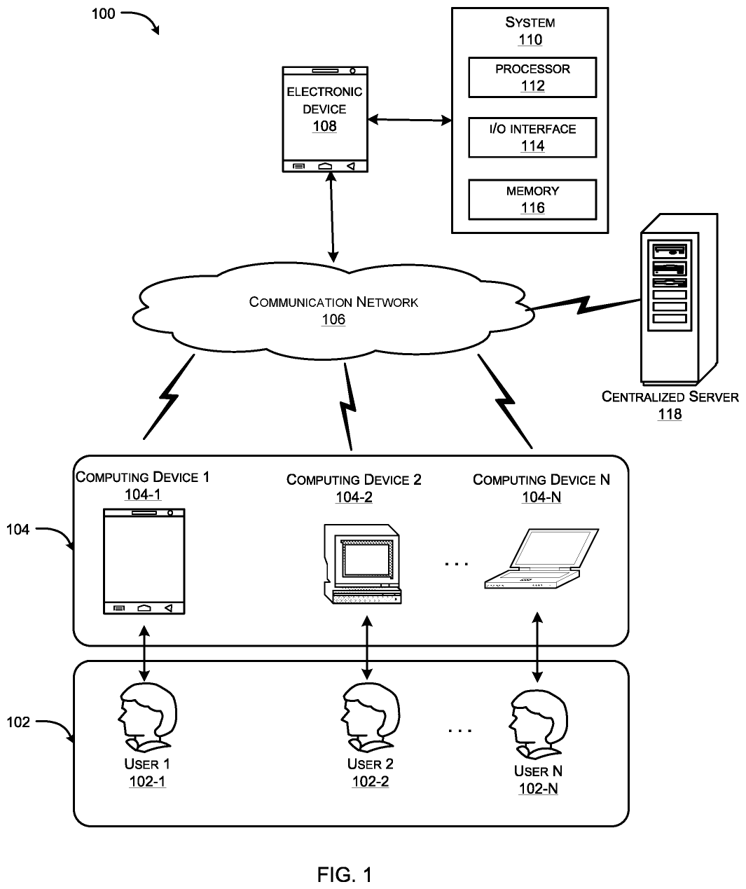

FIG. 1 illustrates an exemplary block diagram representation of a network architecture 100 implementing a proposed system 110 for searching language-agnostic code-mixed queries, according to embodiments of the present disclosure. The network architecture 100 may include the system 110, an electronic device 108, and a centralized server 118. The system 110 may be connected to the centralized server 118 via a communication network 106. The centralized server 118 may include, but are not limited to, a stand-alone server, a remote server, cloud computing server, a dedicated server, a rack server, a server blade, a server rack, a bank of servers, a server farm, hardware supporting a part of a cloud service or system, a home server, hardware running a virtualized server, one or more processors executing code to function as a server, one or more machines performing server-side functionality as described herein, at least a portion of any of the above, some combination thereof, and the like. The communication network 106 may be a wired communication network or a wireless communication network. The wireless communication network may be any wireless communication network capable to transfer data between entities of that network such as, but are not limited to, a carrier network including circuit-switched network, a public switched network, a Content Delivery Network (CDN) network, a Long-Term Evolution (LTE) network, a New Radio (NR), a Global System for Mobile Communications (GSM) network and a Universal Mobile Telecommunications System (UMTS) network, an Internet, intranets, Local Area Networks (LANs), Wide Area Networks (WANs), mobile communication networks, combinations thereof, and the like.

The system 110 may be implemented by way of a single device or a combination of multiple devices that may be operatively connected or networked together. For instance, the system 110 may be implemented by way of a standalone device such as the centralized server 118, and the like, and may be communicatively coupled to the electronic device 108. In another instance, the system 110 may be implemented in/associated with the electronic device 108. In yet another instance, the system 110 may be implemented in/associated with respective computing device 104-1, 104-2, . . . , 104-N (individually referred to as computing device 104, and collectively referred to as computing devices 104). In such a scenario, the system 110 may be replicated in each of the computing devices 104. The electronic device 108 may be any electrical, electronic, electromechanical, and computing device. The electronic device 108 may include, but are not limited to, a mobile device, a smart phone, a Personal Digital Assistant (PDA), a tablet computer, a phablet computer, a wearable device, a Virtual Reality/Augment Reality (VR/AR) device, a laptop, a desktop, server, and the like. The system 110 may be implemented in hardware or a suitable combination of hardware and software. The system 110 or the centralized server may be associated with entities (not shown). The entities may include, but are not limited to, an e-commerce company, a company, an outlet, a manufacturing unit, an enterprise, a facility, an organization, an educational institution, a secured facility, and the like.

Further, the system 110 may include a processor 112, an Input/Output (I/O) interface 114, and a memory 116. The Input/Output (I/O) interface 114 on the system 110 may be used to receive one or more code mixed vernacular queries, from one or more computing devices 104-1, 104-2, 104-N (collectively referred to as computing devices 104 and individually referred as computing device 104) associated with one or more users 102 (collectively referred as users 102 and individually referred as user 102).

Further, system 110 may also include other units such as a display unit, an input unit, an output unit, and the like, however the same are not shown in the FIG. 1, for the purpose of clarity. Also, in FIG. 1 only few units are shown, however, the system 110 or the network architecture 100 may include multiple such units or the system 110/network architecture 100 may include any such numbers of the units, obvious to a person skilled in the art or as required to implement the features of the present disclosure. The system 110 may be a hardware device including the processor 112 executing machine-readable program instructions to search language-agnostic code-mixed queries. Execution of the machine-readable program instructions by the processor 112 may enable the proposed system 110 to search language-agnostic code-mixed queries. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors. The processor 112 may include, for example, but are not limited to, microprocessors, microcomputers, microcontrollers, digital signal processors, central processing units, state machines, logic circuits, any devices that manipulate data or signals based on operational instructions, and the like. Among other capabilities, the processor 112 may fetch and execute computer-readable instructions in the memory 116 operationally coupled with the system 110 for performing tasks such as data processing, input/output processing, and/or any other functions. Any reference to a task in the present disclosure may refer to an operation being or that may be performed on data.

In the example that follows, assume that a user 102 of the system 110 desires to improve/add additional features for searching language-agnostic code-mixed queries. In this instance, the user may include an administrator of a website, an administrator of an e-commerce site, an administrator of a social media site, an administrator of an e-commerce application/social media application/other applications, an administrator of media content (e.g., television content, video-on-demand content, online video content, graphical content, image content, augmented/virtual reality content, metaverse content), among other examples, and the like. The system 110 when associated with the electronic device 108 or the centralized server 118 may include, but are not limited to, a touch panel, a soft keypad, a hard keypad (including buttons), and the like. For example, the user 102 may click a soft button on a touch panel of the electronic device 108 or the centralized server 118 to browse/shop/perform other activities, but not limited to the like. In a preferred embodiment, the system 110 via the electronic device 108 or the centralized server 118 may be configured to receive one or more code mixed vernacular queries from the user via a graphical user interface on the touch panel. As used herein, the graphical user interface may be a user interface that allows a user of the system 110 to interact with the system 110 through graphical icons and visual indicators, such as secondary notation, and any combination thereof, and may comprise of a touch panel configured to receive an input using a touch screen interface.

In an embodiment, the system 110 may receive one or more code mixed vernacular queries, from one or more computing devices. The one or more code mixed vernacular queries include one or more vernacular languages comprising regional languages. Further, the one or more vernacular languages include one or more regional languages words that are written in English script.

In an embodiment, the system 110 may obtain one or more vector representations, using one or more Machine Learning (ML) models for the one or more code mixed vernacular queries. The Machine Learning (ML) models can be any models which supports obtaining one or more vector representations to the one or more code mixed vernacular queries. The one or more vector representations include embedded code-mix queries and English search queries into the common vector representation space. Further, obtaining one or more vector representations may be based on one or more English or multilingual models. The English or multilingual models include at least one of, an encode only models, a decode only models and encoder-decoder models, and the like. Further, one or more vector representations may be quantized to further speed up the search.

In an embodiment, the system 110 may retrieve one or more English queries corresponding to the obtained one or more vector representations. Further, the system 110 may output one or more retrieved English queries corresponding to the one or more code mixed vernacular queries.

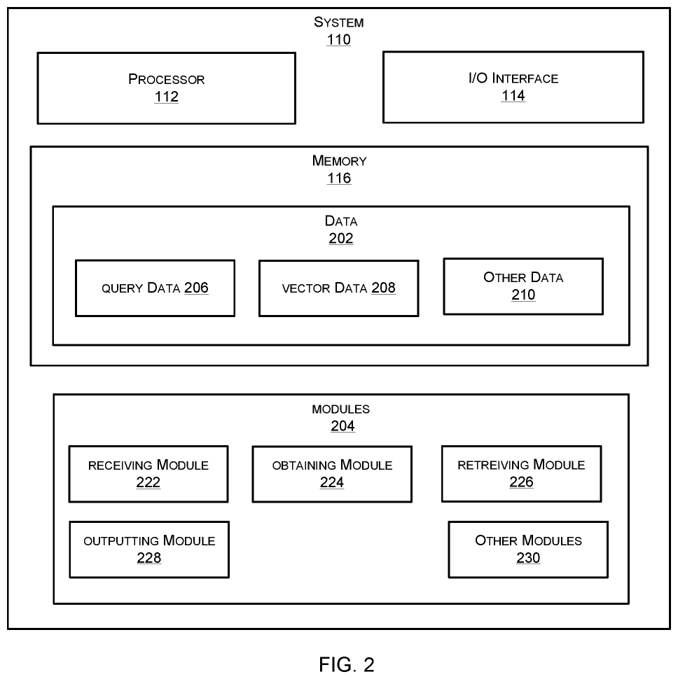

FIG. 2 illustrates a detailed block diagram representation of the proposed system 110, according to embodiments of the present disclosure. The system 110 may include the processor 112, the Input/Output (I/O) interface 114, and the memory 116. In some implementations, the system 110 may include data 202, and modules 204. As an example, the data 202 is stored in the memory 116 configured in the system 110 as shown in the FIG. 2. In an embodiment, the data 202 may include query data 206, vector data 208, and other data 210. In an embodiment, the data 202 may be stored in the memory 116 in the form of various data structures. Additionally, the data 202 can be organized using data models, such as relational or hierarchical data models. The other data 218 may store data, including temporary data and temporary files, generated by the modules 204 for performing the various functions of the system 110.

In an embodiment, the modules 204, may include a receiving module 222, a obtaining module 224, a retrieving module 226, an outputting module 228, and other modules 230.

In an embodiment, the data 202 stored in the memory 116 may be processed by the modules 204 of the system 110. The modules 204 may be stored within the memory 116. In an example, the modules 204 communicatively coupled to the processor 112 configured in the system 110, may also be present outside the memory 116, as shown in FIG. 2, and implemented as hardware. As used herein, the term modules refer to an Application-Specific Integrated Circuit (ASIC), an electronic circuit, a processor (shared, dedicated, or group) and memory that execute one or more software or firmware programs, a combinational logic circuit, and/or other suitable components that provide the described functionality.

In an embodiment, the receiving module 222 may receive one or more code mixed vernacular queries, from one or more computing devices. The one or more code mixed vernacular queries include one or more vernacular languages comprising regional languages. Further, the one or more vernacular languages include one or more regional languages words that are written in English script.

In an embodiment, the obtaining module 224 may obtained one or more vector representations, using one or more Machine Learning (ML) models for the one or more code mixed vernacular queries. The one or more code mixed vernacular queries may be stored as the query data 206. The one or more vector representations include embedded code-mix queries and English search queries into the common vector representation space. Further, obtaining one or more vector representations may be based on one or more English or multilingual models. The English or multilingual models include at least one of, an encode only models, a decode only models and encoder-decoder models, and the like. Further, one or more vector representations may be quantized to further speed up the search. The one or more vector representations may be stored as the vector data 208.

In an embodiment, the retrieving module 226 may retrieve one or more English queries corresponding to the obtained one or more vector representations, from the database of pre-determined vector representations of English queries, using a vector similarity or a requirement-based indexing technique or a hashing technique. Further, the outputting module 228 may output one or more retrieved English queries corresponding to the one or more code mixed vernacular queries.

### Exemplary Scenario

Consider, a scenario where user 102 uses a browser/application/website on the computing device 104. For an instance, consider an e-commerce website/application, in which the user 102 may input non-supported code-mix queries such as vernacular queries (regional language written in English words). The embodiments herein may use a similarity search-based approach for enabling product search in the -commerce website/application with code-mix queries. The system 100 may project the English and code-mix queries onto a common vector space. For an incoming code-mix query, the most similar English query may be found by the system 110 through a vector similarity search. The most similar English query may then can be used as the proxy keyword to carry out product search in the e-commerce website/application. To reduce the latency of the similarity search, efficient hashing or index-based search methods may be used by the system 110.

Initially, for the training of the system 110, from the large set of English queries (possibly millions), the system 100 may find the most similar English query to the incoming code-mixed vernacular query. This English query can then be passed to search Application Programming Interface (API) to obtain a list of relevant products in the e-commerce web site/application.

Hence, the system 100 may pose a search with code-mix queries as a similarity search with respect to English queries. The similarity search may be performed based on the vector representation similarity of the vernacular search queries. The system 110 may embed code-mixed queries and English search queries into the common representation space. For obtaining the vector representation of the queries, a pre-trained or custom fine-tuned, English/multilingual models can be utilized. Specifically, the system 110 may use either encode only models (e.g., Sentence-Bidirectional Encoder Representations from Transformers (BERT)), the decoder only models (e.g., Generative Pre-trained Transformer (GPT)) or encoder-decoder models (e.g., Text-To-Text Transfer Transformer (T5), Bidirectional Auto-encoder Representations from Transformers (BART)) to obtain the vector representation of the query. For the large set (possibly millions) of English queries, the vector representation may be pre-computed offline. For the incoming vernacular code-mixed query from the user 102, the vector representation may be found through efficient similarity search, and retrieve the most similar representation for the English query. The corresponding English query can then be inputted to the search API of the e-commerce website/application. The e-commerce website/application may output relevant product results for the inputted vernacular query.

To enable a fast and efficient similarity search for vectors, the system 110 may use indexing-based or hashing-based approaches. An example of the indexing-based approach may be K Dimensional (KD) tree-based indexing, while an example for the hashing-based approach may be Locality Sensitive Hashing (LSH) technique. In another embodiment, quantizing the vectors may further speed up the search. The approach involves knowledge of different concepts such as representation learning, contrastive learning, efficient search methods such as hash/index-based.

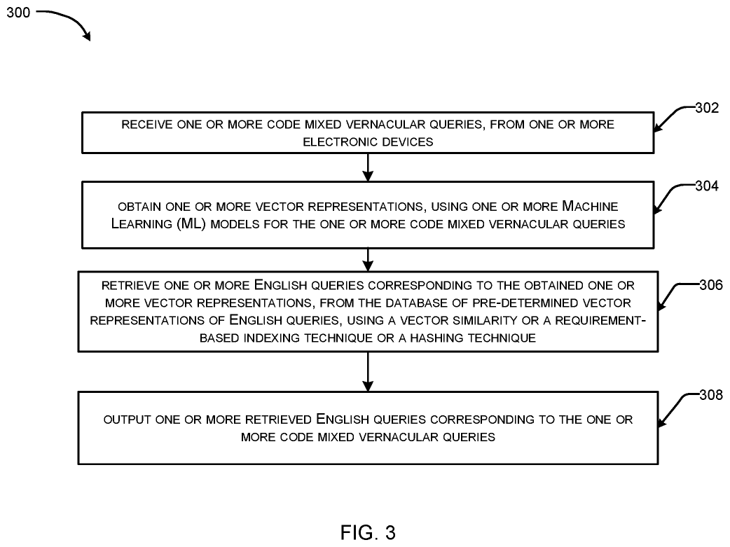

FIG. 3 illustrates a flow chart depicting method 300 of searching language-agnostic code-mixed queries, according to embodiments of the present disclosure.

At block 302, the method 300 includes, receiving, by a processor 112 associated with a system 110, one or more code mixed vernacular queries, from one or more computing devices 104. The one or more code mixed vernacular queries comprise one or more vernacular languages comprising regional languages, and wherein the one or more vernacular languages comprise one or more regional languages words that are written in English script. At block 304, the method 300 includes obtaining, by the processor 112, one or more vector representations, using one or more Machine Learning (ML) models for the one or more code mixed vernacular queries. The one or more vector representations comprises embedded code-mix queries and English search queries into the common vector representation space. Obtaining one or more vector representations may be based on one or more English or multilingual models, wherein the English or multilingual models comprises at least one of, an encode only models, a decode only models and encoder-decoder models.

At block 306, the method 300 includes retrieving, by the processor 112, one or more English queries corresponding to the obtained one or more vector representations, from the database of pre-determined vector representations of English queries, using a vector similarity or a requirement-based indexing technique or a hashing technique. One or more vector representations may be quantized to further speed up the search. At block 308, the method 300 includes outputting, by the processor 112, one or more retrieved English queries corresponding to the one or more code mixed vernacular queries.

The order in which the method 300 are described is not intended to be construed as a limitation, and any number of the described method blocks may be combined or otherwise performed in any order to implement the method 300 or an alternate method. Additionally, individual blocks may be deleted from the method 300 without departing from the spirit and scope of the present disclosure described herein. Furthermore, the method 300 may be implemented in any suitable hardware, software, firmware, or a combination thereof, that exists in the related art or that is later developed. The method 300 describe, without limitation, the implementation of the system 110. A person of skill in the art will understand that method 300 may be modified appropriately for implementation in various manners without departing from the scope and spirit of the disclosure.

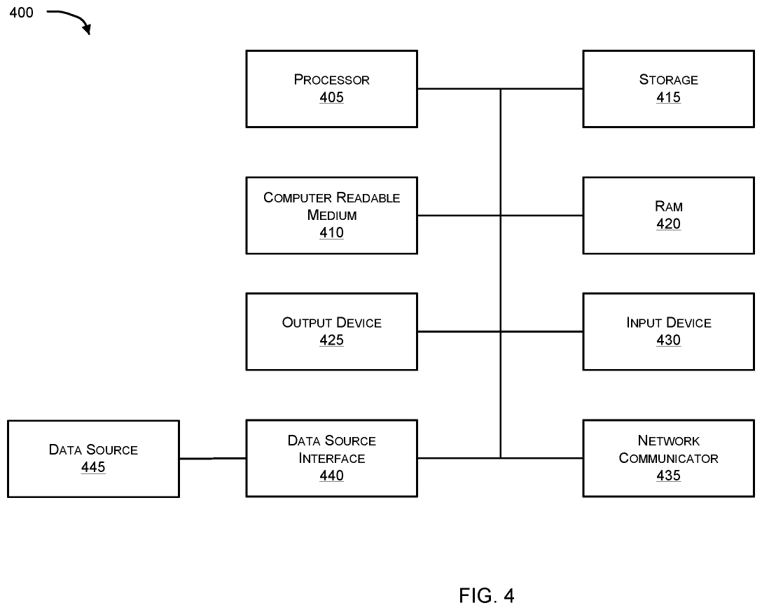

FIG. 4 illustrates a hardware platform 400 for implementation of the disclosed system 110, according to an example embodiment of the present disclosure. For the sake of brevity, construction and operational features of the system 110 which are explained in detail above are not explained in detail herein. Particularly, computing machines such as but not limited to internal/external server clusters, quantum computers, desktops, laptops, smartphones, tablets, and wearables which may be used to execute the system 110 or may include the structure of the hardware platform 400. As illustrated, the hardware platform 400 may include additional components not shown, and that some of the components described may be removed and/or modified. For example, a computer system with multiple GPUs may be located on external-cloud platforms including Amazon® Web Services, or internal corporate cloud computing clusters, or organizational computing resources, etc.

The hardware platform 400 may be a computer system such as the system 110 that may be used with the embodiments described herein. The computer system may represent a computational platform that includes components that may be in a server or another computer system. The computer system may execute, by the processor 405 (e.g., a single or multiple processors) or other hardware processing circuit, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor 405 that executes software instructions or code stored on a non-transitory computer-readable storage medium 410 to perform methods of the present disclosure. The software code includes, for example, instructions to gather data and documents and analyze documents. In an example, the modules 204, may be software codes or components performing these steps.

The instructions on the computer-readable storage medium 410 are read and stored the instructions in storage 415 or in random access memory (RAM). The storage 415 may provide a space for keeping static data where at least some instructions could be stored for later execution. The stored instructions may be further compiled to generate other representations of the instructions and dynamically stored in the RAM such as RAM 420. The processor 405 may read instructions from the RAM 420 and perform actions as instructed.

The computer system may further include the output device 425 to provide at least some of the results of the execution as output including, but not limited to, visual information to users, such as external agents. The output device 425 may include a display on computing devices and virtual reality glasses. For example, the display may be a mobile phone screen or a laptop screen. GUIs and/or text may be presented as an output on the display screen. The computer system may further include an input device 430 to provide a user or another device with mechanisms for entering data and/or otherwise interacting with the computer system. The input device 430 may include, for example, a keyboard, a keypad, a mouse, or a touchscreen. Each of these output devices 425 and input device 430 may be joined by one or more additional peripherals. For example, the output device 425 may be used to display the results such as bot responses by the executable chatbot.

A network communicator 435 may be provided to connect the computer system to a network and in turn to other devices connected to the network including other clients, servers, data stores, and interfaces, for instance. A network communicator 435 may include, for example, a network adapter such as a LAN adapter or a wireless adapter. The computer system may include a data sources interface 440 to access the data source 445. The data source 445 may be an information resource. As an example, a database of exceptions and rules may be provided as the data source 445. Moreover, knowledge repositories and curated data may be other examples of the data source 445.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as a limitation.

### Advantages of the Present Disclosure

The present disclosure provides a method and a system for searching language-agnostic code-mixed queries.

The present disclosure provides a similarity search-based approach for enabling search with code-mixed queries.

The present disclosure enables English and code-mix queries to be projected onto a common vector space, and most similar English query is found through vector similarity search.

The present disclosure reduces the latency of the similarity search, using efficient hashing or index-based search methods.

The present disclosure use either encode-only models, the decoder-only models, or encoder-decoder models to obtain the vector representation of the query.

The present disclosure performs quantization of the vectors to speed up the search.

The present disclosure avoids translation of code-mix query to English query, which also adds labeling cost for the translation.

The present disclosure avoids manually labeling parallel corpus data of code-mixed queries, which may be time-consuming and expensive.

What is claimed is:

1. A method for searching language-agnostic code-mixed queries, the method comprising:
receiving, by a processor associated with a system, one or more code mixed vernacular queries, from one or more computing devices;
obtaining, by the processor, one or more vector representations, using one or more Machine Learning models for the one or more code mixed vernacular queries;
retrieving, by the processor, one or more English queries corresponding to the obtained one or more vector representations, from the database of pre-determined vector representations of English queries, using a vector similarity or a requirement-based indexing technique or a hashing technique; and
outputting, by the processor, one or more retrieved English queries corresponding to the one or more code mixed vernacular queries.

2. The method as claimed in claim 1, wherein the one or more vector representations comprises embedded code-mix queries and English search queries into the common vector representation space.

3. The method as claimed in claim 1, wherein the one or more code mixed vernacular queries comprise one or more vernacular languages comprising regional languages, and wherein the one or more vernacular languages comprise one or more regional languages words that are written in English script.

4. The method as claimed in claim 1, wherein the obtaining one or more vector representations is based on one or more English or multilingual models, wherein the English or multilingual models comprises at least one of, an encode only models, a decode only models and encoder-decoder models.

5. The method as claimed in claim 1, wherein one or more vector representations is quantized to further speed up the search.

6. A system for searching language-agnostic code-mixed queries, the system comprising:
a processor;
a memory coupled to the processor, wherein the memory comprises processor-executable instructions, which on execution causes the processor to:
receive one or more code mixed vernacular queries, from one or more computing devices;
obtain one or more vector representations, using one or more Machine Learning models for the one or more code mixed vernacular queries;
retrieve one or more English queries corresponding to the obtained one or more vector representations, from the database of pre-determined vector representations of English queries, using a vector similarity or a requirement-based indexing technique or a hashing technique; and
output one or more retrieved English queries corresponding to the one or more code mixed vernacular queries.

7. The system as claimed in claim 6, wherein the one or more vector representations comprises embedded code-mix queries and English search queries into the common vector representation space.

8. The system as claimed in claim 6, wherein the one or more code mixed vernacular queries comprise one or more vernacular languages comprising regional languages, and wherein the one or more vernacular languages comprise one or more regional languages words that are written in English script.

9. The system as claimed in claim 6, wherein the obtaining one or more vector representations is based on one or more English or multilingual models, wherein the English or multilingual models comprises at least one of, an encode only models, a decode only models and encoder-decoder models.

10. The system as claimed in claim 6, wherein one or more vector representations is quantized to further speed up the search.
